(19) United States
(12) Patent Application Publication
(10) Pub. No.: US 2019/0251649 A1
(43) Pub. Date: Aug. 15, 2019

(54) Bereavement and financial administrative assistant and estate asset organizational system

(71) Applicant: Smooth Exits LLC, Delray Beach, FL (US)

(72) Inventor: Samuel R. Bierstock, Delray Beach, FL (US)

(21) Appl. No.: 16/275,959

(22) Filed: Feb. 14, 2019

Related U.S. Application Data
(60) Provisional application No. 62/631,106, filed on Feb. 15, 2018.

(51) Int. Cl. G06Q 50/18; G06F 21/60; G06F 21/62

(52) U.S. Cl. CPC G06Q 50/186; G06Q 2220/00; G06F 21/6245; G06F 21/604

(57) ABSTRACT

An organizational and actionable system performed on a computer for planning and management of the personal and financial affairs of an individual prior to and following death or incapacitation. The system will allow a user to disclose to a trusted party the whereabouts of assets that may not have been disclosed while alive (intentionally or unintentionally) and to minimize the or care-givers time that might otherwise be spent by survivors in hunting down assets, trying to navigate personal computers for key files and folders, searching for business agreements or benefits of which they may not have been aware to provide a comprehensive estate planning guide.

### PRIORITY CLAIM

In accordance with 37 C.F.R. 1.76, a claim of priority is included in an Application Data Sheet filed concurrently herewith. Accordingly, the present invention claims priority under 35 U.S.C. § 119(e), 120, 121, and/or 365(c) to U.S. Provisional Patent Application No. 62/631,106, entitled “BEREAVEMENT ASSISTANT AND ESTATE ASSET ORGANIZATIONAL SYSTEM”, filed on Feb. 15, 2018. The contents of which the above referenced application is incorporated herein by reference in its entirety.

### FIELD OF THE INVENTION

This invention is related to the field of assuring the identification of and location of all of an individual's assets and obligations for those responsible for administration of their estates following their death or incapacitation, reducing administrative obligations of spouses, life partners and surviving loved ones or designees during the bereavement period following the death of the individual or loved one or during incapacitation of that individual or loved one and, in particular, to a bereavement and financial and administrative assistant combined with an estate planning organizational system employing a computer system and dashboard screen display.

### BACKGROUND OF THE INVENTION

The term “Estate planning” is used in this document to describe the process of making arrangements for the passing or incapacitation of an individual while the individual can participate. Estate planning is much greater than simply preparing a Will or a Trust. Proper estate planning anticipates the problems associated with the loss or incapacitation of an individual and arranges for the administration of and/or disposal of the individual's estate to maximize the value of the estate and minimize the burden upon relatives. Unfortunately, a majority of estate planners limit their planning to a Will & Trust since asset summarizing can appear to be overly burdensome and, if an attorney is involved, overly expensive.

While there are many estate asset summarizing products available for estate planning, no known product offers a degree of granularity or ability to include types of estate assets and responsibilities rarely otherwise included in conventional estate planning guides. There also no known software dedicated to streamlining, monitoring, and performing the administrative and financial steps and decisions that need to be made during the period of immediate and continued bereavement. The same holds true for the passing on of information and the administrative and financial steps and decisions that need to be made when an individual or loved one is mentally or physically incapable of such actions due to illness that is chronic (terminal disease or mental incapacitation) or acute (sudden illness or injury such as heart attack, stroke, injury or other incapacitating conditions).

### SUMMARY OF THE INVENTION

Disclosed is an organizational and actionable system for the comprehensive planning and management of the personal and financial affairs of an individual prior to and following death or during physical or mental incapacitation. The system is designed to ease the burden of surviving spouses, life-partners and loved ones during the most difficult and emotional immediate period following their loss or the need to provide care, when the pressures for important decision making and administrative steps to be taken can otherwise be overwhelming. In addition, the system will allow a primary user (the person summarizing their assets, wishes and responsibilities—referred to hereafter in this document as “PU”) to disclose to a specified trusted party the whereabouts of assets that may not have been disclosed while alive (intentionally or unintentionally) and to minimize the time that might otherwise be spent by survivors in hunting down assets, trying to navigate personal computers for key files and folders, searching for business agreements or benefits of which they may not have been aware, etc. In short—assets that are rarely included in conventional estate planning guides.

An objective of the invention is to minimize the steps and decisions that must be made during the most difficult period of loss or transfer of financial and administrative responsibilities, automate them and allow for the grieving or care-giving parties to grieve or meet these responsibilities, while minimizing the associated pressures of steps to take and decisions to make—and to monitor and report the status and progress of required actions

Another objective of the invention is to provide a bereavement assistant, end-of-life planner, and comprehensive asset location and identification application designed to minimize administrative necessities and allowing time to be devoted to grieving, and to minimizing the search for assets and otherwise not-commonly-disclosed assets—reducing the time and costs associated with months if not years of searching in many cases. The application may be used from any computer or portable smart device. These same capabilities are applicable to individuals finding themselves primarily responsible for the care of an ill or incapacitated loved one or individual.

Still another objective of the invention is to disclose a dashboard screen display mapping critical components of the estate planning, asset itemization, and otherwise non-conventionally disclosed or customized information system with targeted PU-defined levels of permission for protected and confidential access to each item of information.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a chart of the Phases of Assistance;

FIG. 2 is a Bereavement Assistant Flow Chart;

FIG. 3 is an illustration of a sample Dashboard from which data is extracted for Bereavement & Incapacitation Assistant Functionality;

FIG. 4 is a Sample Personal Information and Demographics screen;

FIG. 5 is a Sample Reminder List;

FIG. 6 is a flow chart of password connecting;

FIG. 7 is a flow chart password connecting with two factor authentication;

FIG. 8 is a flow chart of the login process;

FIG. 9 is a flow chart of a web server connecting to cloud databases;

FIGS. 10A, 10B, 10C and 10D is a chart of secure data storage where 10A shows Entry Point Database, 10B shows Secure Data Tables for Database 1, 10C shows Secure Data Tables for Database 2, and 10D shows Secure Data Tables for Database 3, etc.

FIG. 11 is a chart of Artificial Intelligence (AI) actions.

### DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

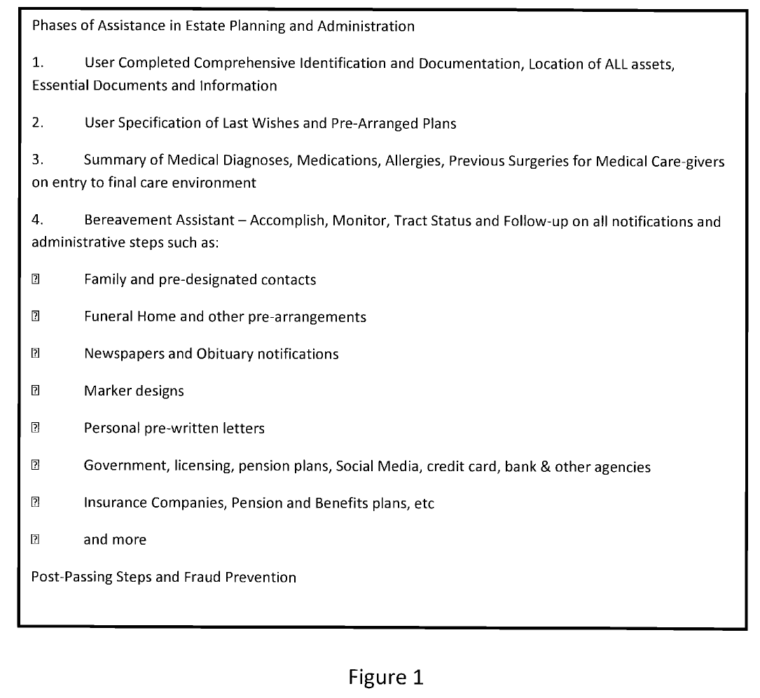

The instant invention is an organizational and actionable system for the comprehensive planning and management of the personal and financial affairs of an individual prior to and following death, or during physical and/or mental incapacitation. Referring to FIG. 1, depicted are the phases of assistance required in estate planning and administration.

The system is designed to ease the burden of surviving spouses life=partners and loved ones during the most difficult and emotional immediate period following their loss or incapacitation, when the pressures for important decision making and administrative steps to be taken can otherwise be overwhelming. The system performed on a computer with software is configured for maximal security making unauthorized access virtually impossible, and protecting the data from access or attack by parties other than those with whom the user has shared his or her encrypted password.

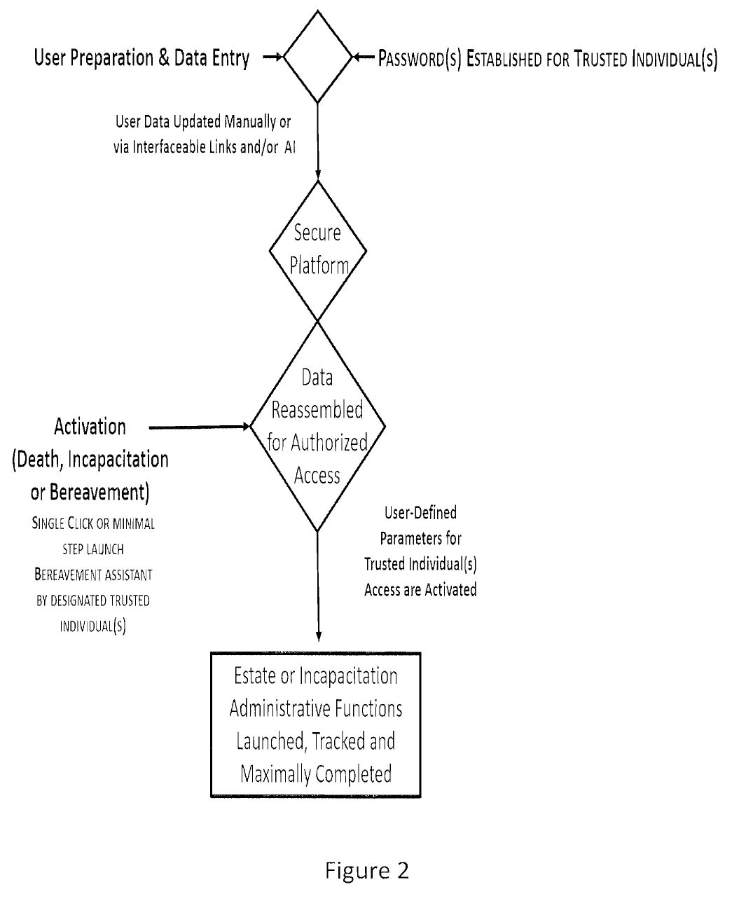

FIG. 2 summarizes the phases of assistance by depicting the three areas of use provided by the instant invention, namely: Preparation, Activation and Efficient Estate Administration. In the Preparation phase a Principal User (PU) summarizes their wishes for matters related to their final disposition at the time of their death using comprehensive guide, the PU compiles information for each section that applies to their individual financial and personal situation & wishes and the PU provides password(s) to key trusted individual(s) (TI) for their use at the time of user's death or incapacitation. The term “Passwords” is understood to include all form of biometric identification, facial or other forms recognition and alpha-numerical combinations—or a combination of any of these methods of identification providing access to the system. Information may be entered into the system using direct data entry by the PU via keyboard, voice recognition, video or other means of data entry, or gathered by Artificial Intelligence capabilities embedded in the system functionality.

The Activation phase at the time of user's passing or incapacitation, TI uses ONE-CLICK (and confirmation/editing clicks as needed) technology to automatically have all stored on maximally secure platform which may include a system for scrambled data to be re-assembled (see Figure X and associated description) or block-chain technology or other secure technologies and all required steps completed and sent when applicable including: Pre-designated contacts notified (preconfigured or dictated message), funeral home and pre-arrangement notifications; newspaper notifications and obituary provision, banks, credit card companies, insurance companies, pension and retirement plans, membership organizations, government agencies, etc. notified, and when required pre-completed forms generated with death certificates ordered and/or sent.

In the Efficient Estate Administration phase, TI uses comprehensive summary of completed information to locate all assets and information well beyond that contained in a conventional asset summary—saving thousands of hours of post-passing searching and associated expense.

During the Preparation phase, the PU documents a comprehensive listing of all personal and financial data, and all accounts, memberships, licenses, professional relationships, business contracts, real estate matters (rents present and contracted), regular bills to be paid, business and employment benefits, location and access to safes, hiding places and other assets not otherwise disclosed, location of key documents, access to computers and location of key files and folders, website usernames and passwords, personal letters to individuals following death, all insurance policies, social media presence and activity, storage units, safety deposit boxes, emails addresses, business agreements that survive death, firearms owned and locations, ancestry and family history information to be passed on, genetic profiles, and more. In addition the user may define their wishes with respect to final services and disposition of their remains, design their grave markers and inscriptions, write their own obituaries and select a picture to accompany their obituary. Location of wills, power of attorney, advanced directives and health care surrogates are listed, or copies may be attached to the file. Bills paid regularly and other obligations for the management of personal household and family matters, etc. are also summarized as well as automated payments, online payments systems etc.

The Activation phase may be initiated upon the death of the user by a Trusted Individual (TI) with whom he or she has shared the password or who has established other unique identifier technologies to the application. The system is designed so that upon activation (and confirmation of activation if so configured), electronic notifications are sent to pre-selected contacts, funeral home or pre-arranged services, newspaper obituary announcements, banks, credit card companies, government agencies, membership groups etc. The system may also be configured to send state and federal agency pre-completed forms (with date of death and other key information auto-populated) to their respective reporting agencies. Individuals contacted may be notified of funeral arrangements or advised to check the funeral home website for details. Wherever possible, Artificial Intelligence capabilities are used by a computer coupled to an internet to identify entities requiring notification from the information previously entered by the PU or from other databases and sources of information such as credit bureau databases, previous tax returns, or other data sources which may have data pertaining to bank accounts, investment accounts, liabilities held, licenses, real estate owned, memberships, subscriptions, pension plans, insurance policies, benefits due, etc. and to submit the notifications and complete required forms—as well as monitor and act upon follow-up information requests or steps to be taken. The computer learns which entities are required to expedite the identifying step and searches for additional entities. The system will remind PU's to update information whenever required or if it is changed, and artificial intelligence will recognize and identify whenever possible, any change in formation that requires updating in the system—so notifying the PU and confirming the update. Requests for remembrance gifts or donations (for instance—in lieu of flowers), time and place of funeral ceremonies, gatherings or burials etc. may be included in automated notifications.

During the Post-Passing Administrative, or incapacitation Phase, the Trusted Individual (spouse, life-partner, attorney, family member—whoever has been so designated by the PU) may access the file using the password shared in trust by the PU to obtain all of the information that would otherwise have taken weeks, months or years (if ever) to locate and compile. Since the system will contain virtually all of the personal and financial, total-life administrative information of the user, security of the information is absolutely essential. For this reason the data will not reside on any personal computer, or smart device. While the questions and forms to be completed will be visible and interactive from such devices, all data will be encrypted and securely protected via maximally secured secure platform, including for example, block chain technology or disassembled data so as to be unreadable and uninterpretable when not accessed using the encrypted password of the user. This data would be dispersed and shared on multiple servers so that an attack on any server to access data will result in unreadable data. Only when the encrypted password is used, will the data be reassembled from all servers and delivered for viewing or printing to the device using the authorized password. This represents a unique form of data security applied to this specific use in comprehensive end-of-life planning. The system is performed on a computer, cell phone, or other “smart device” with the following sample screen displays eliciting information for final display.

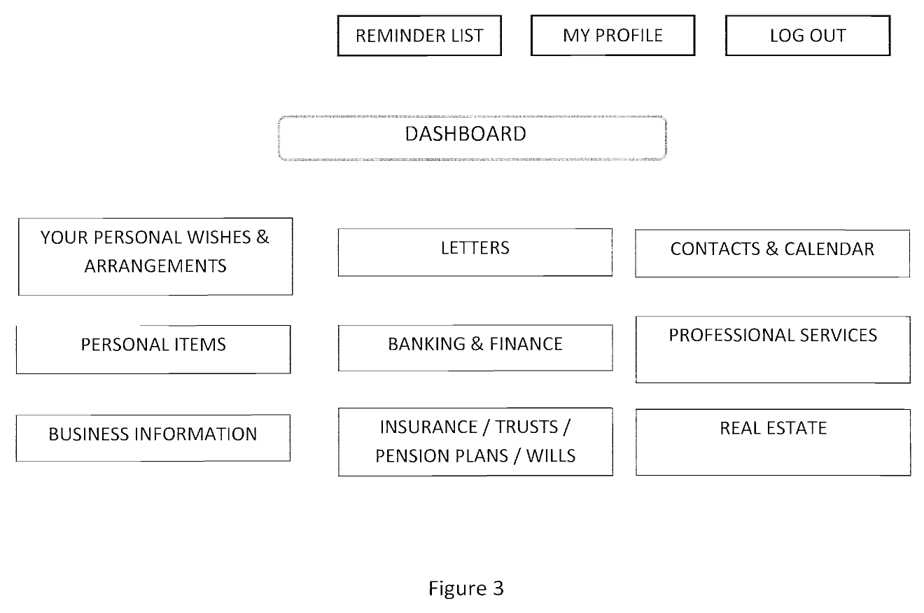

Sample Dashboard—Referring to FIG. 3, each item opens onto a display for entry of detailed information pertaining to the general category. Any Latin Designations in these illustrations represent placeholders. As information is entered the system monitors and automates essential administrative functions to be activated when required such as the number of death certificates to order (originals and copies as required) and to whom they need to be send, contacts to be notified, publications and websites to receive obituary announcements and pictures to accompany the announcements, funeral and memorial gatherings arrangements and notifications, ordering of items, etc. using entered information and associated artificial intelligence data.

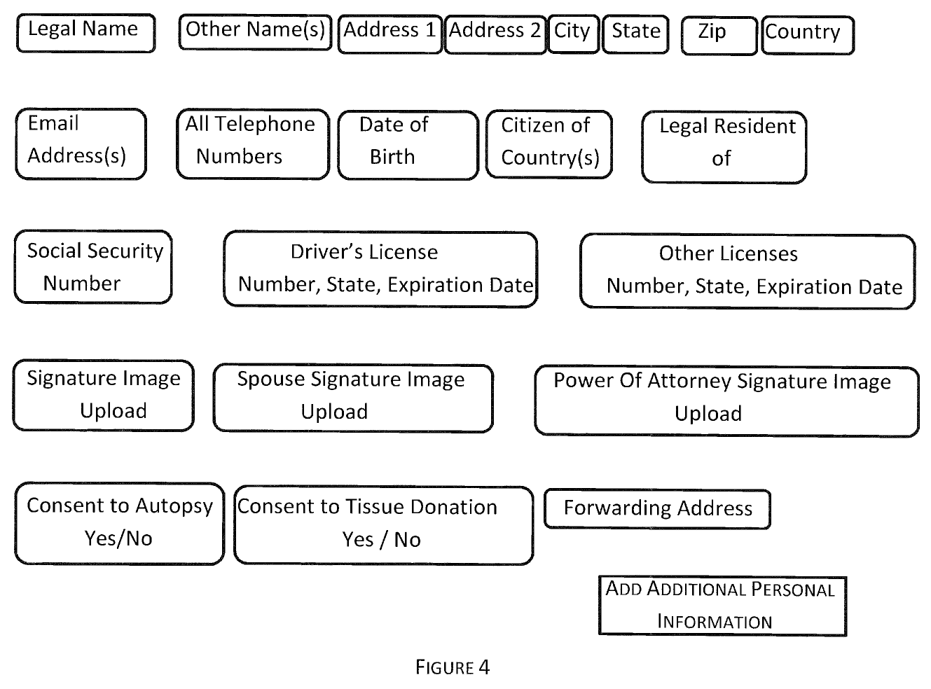

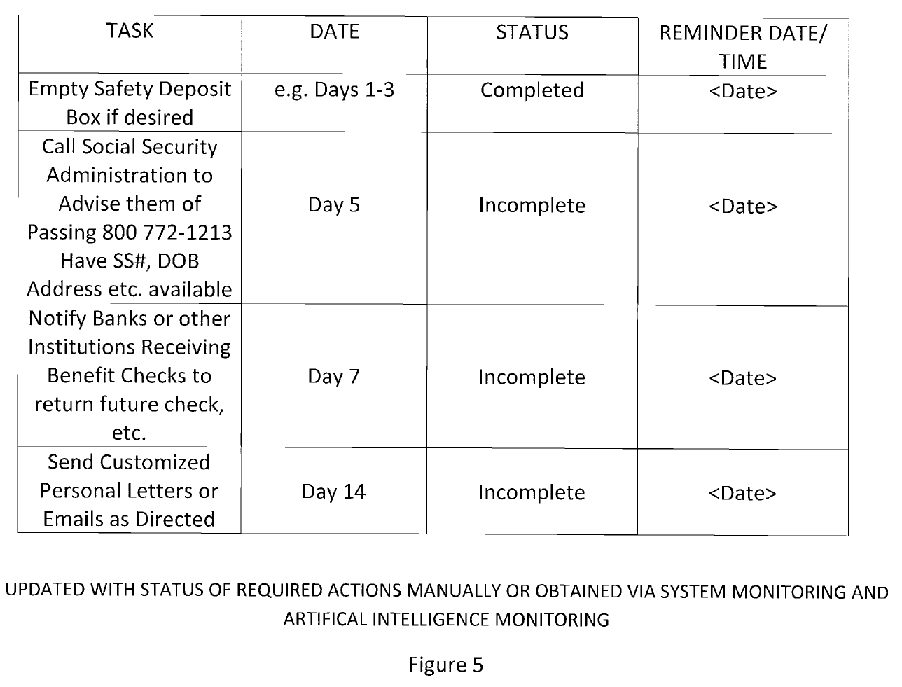

FIG. 2 depicts the bereavement assistant flow chart. Referring to FIG. 3, depicted is the Dashboard screen display which simplifies the coordination of the above system using base elements Review, Save, Activate, Print and Add Item. From the base elements the system provides drop down screen displays. Sample Personal Information and Demographics screen is illustrated in FIG. 4. Sample Reminder Display of Actions to be taken tied to specific times and customized action dates is set forth in FIG. 5.

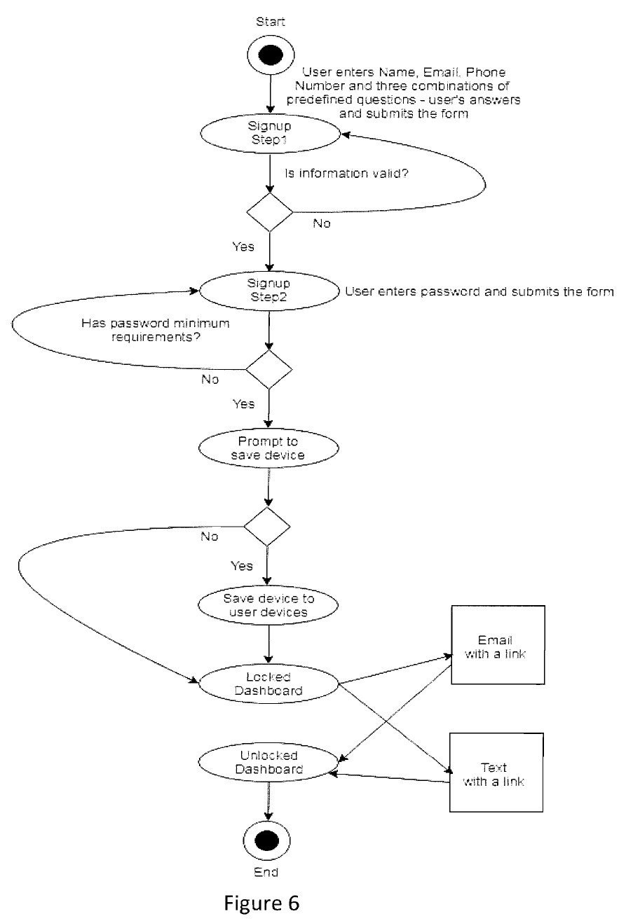

SECURITY PLATFORM. Website access and user signup activity diagram is set forth in FIG. 6. The diagram shows the user signup process, on the website. When the user visits the URL “https://domain.tld/register” they are prompted with a signup form step 1 in which they will enter: Email, Name, Phone Number, Date of Birth, last 4 digits of the Social Security Number (SSN) or other specified or government issued identifier(s) and Three combinations of predefined questions—user's answers that might need to be used later for the login process (See Login Activity Diagram), if this information is valid (Valid email, Name and Phone Number format and the Email is not taken in the system and the required fields are not empty), we prompt the user with the step 2 of the signup, in which a password will be requested, that way we don't submit the password and email together, the password, if alpha-numerical should have at least 10 characters, one number, one capital letter and one special character (+−*/#%$\hat{ }). We ask the user if he wants to save the device to its list of devices, if the answer is yes we try to grab any device id such as UDID or IP and save it to the user's device list.

The user enters to the dashboard although the account is locked; the user cannot upload or save any data yet until the Email and Phone Number are confirmed. In the dashboard we can show a message with button to send an email and a text, to unlock it. The email and text will have a link with a token to confirm the email and password, once the email and password are confirmed the account will be unlocked and the user will be able to use its account.

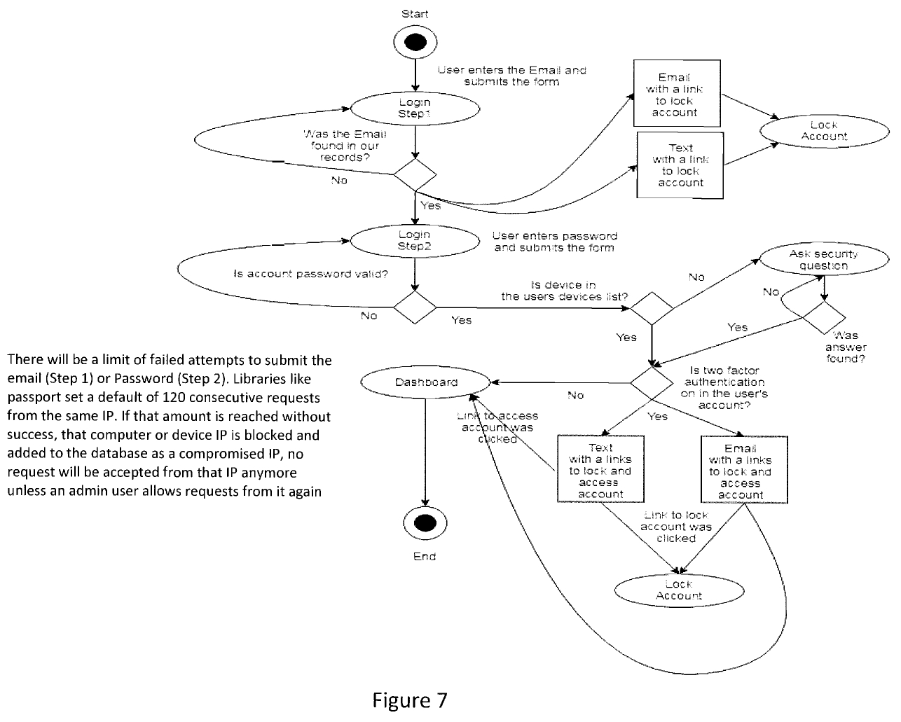

User login activity diagram. Referring now to FIG. 7, the diagram shows the user login process, on the website. When the user visits the URL “https://domain.tld/login” they are prompted with a login form step 1 in which they will enter their Email. If the email is found in the database an email and a text is sent to the user with a link to lock its account right away in case the activity was not recognized as legitimate. The user in the site is then prompted with the Signup Step 2, in which he will enter the password. If the password matches the user's account and the device the user is using to login is not recognized as a known device, one of the three security question related to the user's account is asked when answered correctly or the device is recognized as a saved device he can move on. If two factor authentication is on in the users account an email and a text will be sent with two links, one with a token to be able to login and another to be able to lock down the account in case the user considers that the action is not legitimate.

If the user clicks on the lock account link, the account will be locked down, “the unlock the account” process is basically the same as the Email and Phone Number confirmation described in the signup process. If the user clicks the login link it will be logged in using a one time use token on the link. In addition to individual user determined passwords, use of the word “Password” or “Encrypted Password” in this document is intended to include all forms of current and future technology for individual identification including but not limited to bio-identification such as finger print, iris and retinal topography, genetic identification, voice, facial recognition, etc., and/or external devices used for identification such as proximity cards or other identification devices, or any combination thereof.

User Account Security. Upon login the server set sessions and will respond with a public key (it will be stored in the local storage of the device) that will be used to request a one time use authentication token (it will be stored in the front end code), which has to be sent to the server along with every form submission or request. If the authentication token sent to the server along with the request is not valid, the user will be logged out of their account. The user can be logged in the account with more than one device at the same time, one public key will be generated per logged in device. The public key will expire 24 hours after the last action is saved to the database. The one use authentication token also expires after 24 hours, if it is not used. The reason we use a Public Key and a one use authentication token is because if the user refreshes the page, since the token is stored in the front end code it will be gone and then with the Public Key and the session a new one can be requested.

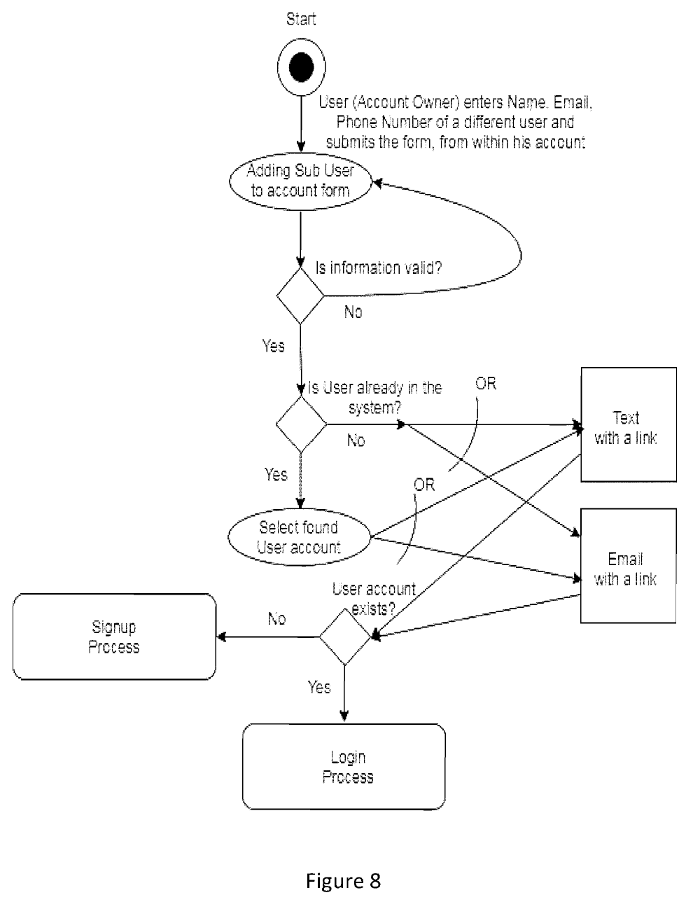

Sub Users Account Creation. Referring to FIG. 8, after a user (account owner) is logged into his, he account can create a “Sub user account”, this account will have access and privileges as per account owner (or principal planner) selection. These Sub user accounts are the same as any other user account and can have access to many accounts (if these accounts owners decide to give them access) and even have one of its own. Permits will be defined by the account owner to allow other users to access specific data and with definite privileges (Owner, Editor, Viewer, Admin, etc. . . . ). The account owner or principal planner will also be able to limit what each sub user sees if he so chooses. The account owner will enter the Sub user name, email and phone number. We check for the entered data in the database, if the user exists we select that user account otherwise we enter the new user and send an email or text with an invitation to access the account, the account owner can start to set permits and privileges for the Sub user account to access his Secure Data as soon as it is created or selected. When the “Sub user” clicks the link in the email or text we collect the rest of the information, if needed (if it's not an existing account).

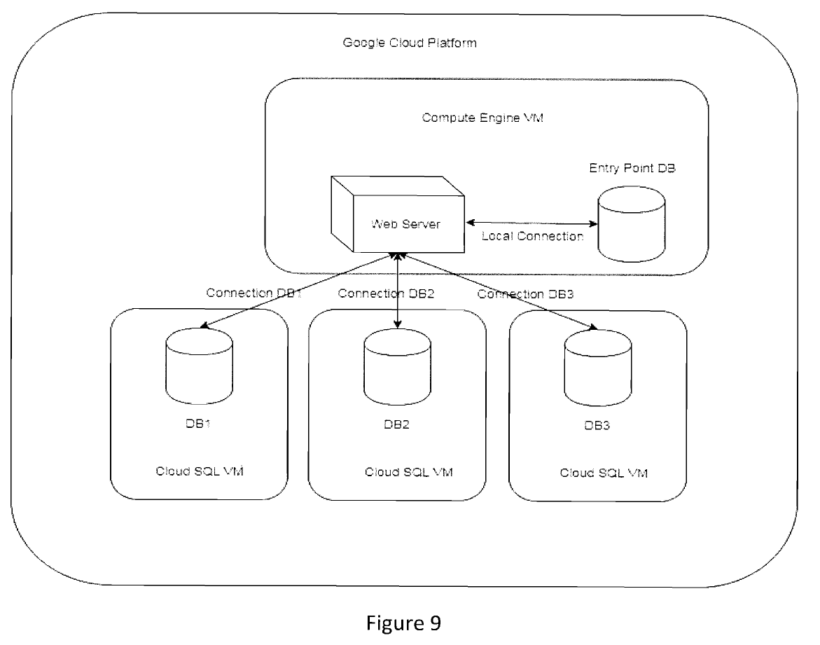

Referring to FIG. 9, the diagram shows the suggested technologies (Google Cloud Platform) and design (Compute Engine, Cloud SQL) to be used. The Compute Engine VM will run apache (Web Server) and MySQL (Database Server), it will hold the “Entry Point Database” which will contain all data that manages the website and the entry point to the user “Secure Data” that will be stored in the Cloud SQL VMs (DB1, DB2 and DB3) in chunks (this will be explained in more detail in the next chapter), The connection between the Web Server and the Entry Point DB will be through the local host (Connection from within the same Web Server VM, database connection from any other computer will not be allowed). The connection between the Web Server and DB1, DB2 and DB3 is secured by the Google Cloud Platform, allowing only connections coming from the Server's IP. Backups for each DB should be scheduled in a daily basis. Note: any brand name database server, VM, cloud, or other can be used as the software is the intellectual property and it can be used on any of them.

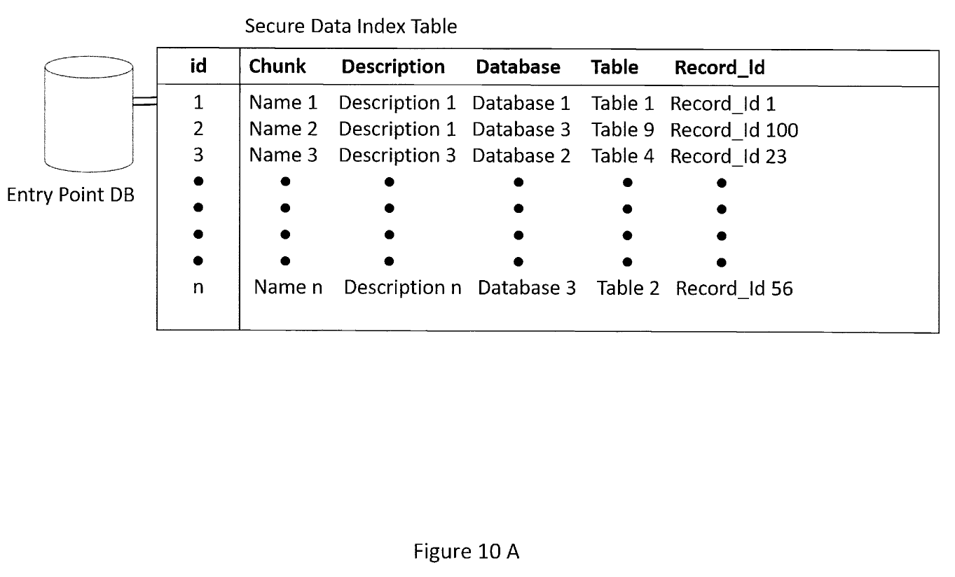

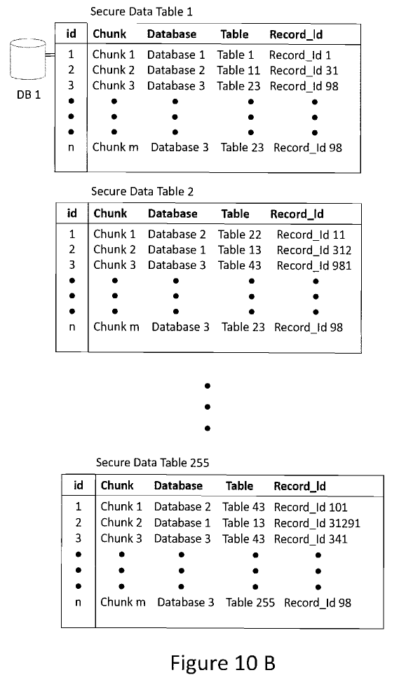

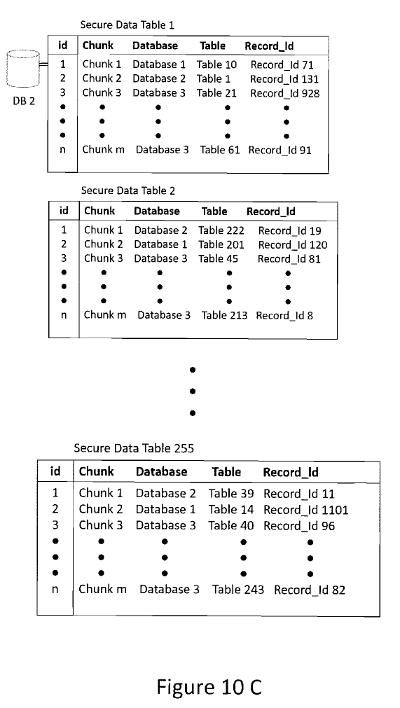

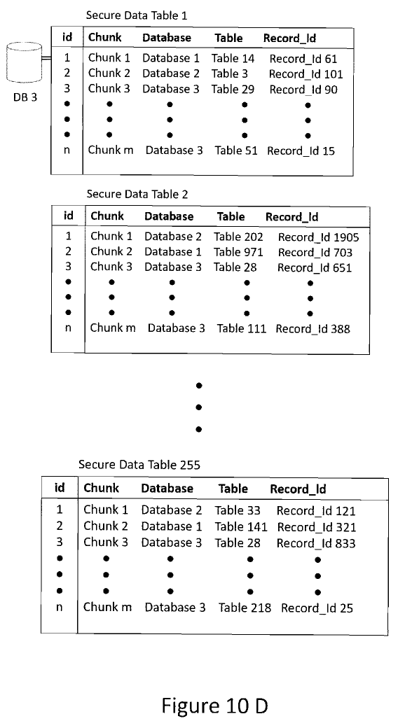

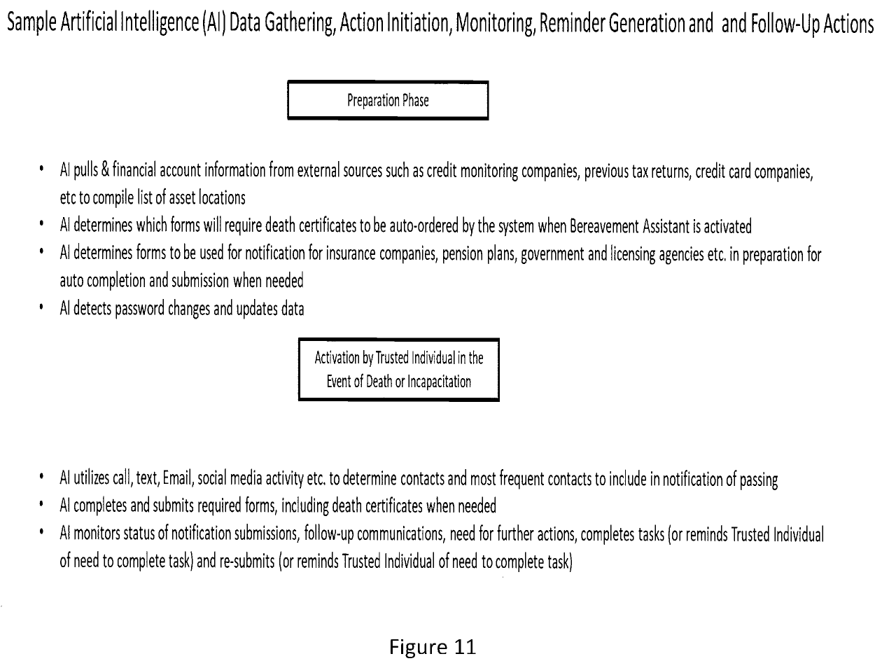

Database Design is focused on storage of “Secure Data”. Referring to FIG. 10, the diagram shows the design for the Secure Data storage, as we can see there will be an Entry Point Table that will live in the Web Server database “Entry Point DB”, this table will have a reference to the first “Chunk” of data that can be in any of the 255 tables that can be found in any of the three DBs (DB1, DB2 or DB3) that live on its own VM, as shown in the Database Connection Diagram, each chunk record will also have a reference to the next chunk of data and so on until the last piece of the Secure Data is found. Each chunk of data will be a base 64 encoded string and can be up to 64 Kb in size (65 535 chars, using single-byte characters), that way we ensure a fast lookup thru the data.

### Example

Let's suppose the user upload a PDF file. When the PDF is uploaded to the front end tool we base64 encode and divide it in 1.5 MB chunks of data; the 1.5 MB chunks are sent to the Web Server one by one. We send one 1.5 MB chunk and when the response comes back from the Web Server the next one is sent and so on until the entire file is saved in the Secure Data DBs.

When The Web Server receives the request to save one 1.5 MB chunk of data, along with the data, we will get back the previous' chunk DB number, Table number and Record ID, if it is not the first chunk, to connect or create a reference between each other. If the 1.5 MB chunk is the first one of the entire file, the name, description, etc. . . . will come along with data and will be stored in the Entry Point DB, that way when the user search for a file we only perform the search on the Entry Point DB without even trying to access the file data stored in the Secure Data DBs. In a similar way the Web Server will divide each 1.5 MB chunk of data in smaller pieces (64 Kb), saving and linking each of them through the Secure Data DBs, in this process we select the DB and Table randomly.

Use of the word “computer” in this document is intended to include all forms of current and future technology for digital communications including computers, smart phones, and smart tablets, or any combination thereof. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A computer driven systematic method for bereavement and estate asset organizational comprising the steps of:
providing an on-line accessible questionnaire by an application executing on A computer device coupled to an internet;
inputting as a preparation phase a questionnaire including a listing of a user's personal data which includes financial data, all accounts, memberships, licenses, professional relationships, business contracts, real estate matters (rents present and contracted), regular bills to be paid, business and employment benefits, location and access to safes, hiding places and other assets not otherwise disclosed, location of key documents, access to computers and location of key files and folders, usernames and passwords, personal letters to individuals following death, all insurance policies, social media presence and activity, storage units, safety deposit boxes, emails addresses, business agreements that survive death, firearms owned and locations, ancestry and family history information to be passed on, genetic profiles;
identifying, by a computer coupled to an internet, entities requiring notification of bereavement comprising credit bureau databases, previous tax returns, data sources which may have data pertaining to bank accounts, investment accounts, liabilities held, licenses, real estate owned, memberships, subscriptions, pension plans, insurance policies, and benefits due;
learning, by the computer, which entities are required to expedite the identifying step and searching for additional entities;
encrypting data by the application executing on the computer device said data to be disassembled and uninterpretable when not accessed using an encrypted password of the user;
accessing said encrypted data through an activation phase by the application executing on the computer device upon the death or incapacitation of the user by a Trusted Individual;
confirmation of activation and decrypting said encrypted data upon acceptance of confirmation;
sending electronic notifications by the application executing on the computer device pre-selected contacts, funeral home or pre-arranged services, newspaper obituary announcements, banks, credit card companies, insurance and pension plans, government agencies, and membership groups; and
forwarding state and federal agency by the application executing on the computer device pre-completed forms to their respective reporting agencies; and
displaying a dashboard of basic elements by the application executing on the computer device providing a checklist of post passing or incapacitation administrative elements.

2. The computer driven systematic method for bereavement and estate asset organizational according to claim 1 wherein said data is dispersed onto multiple servers so that an attack on any server to access data will result in unreadable data.

3. The computer driven systematic method for estate asset organizational according to claim 2 wherein said data is be reassembled from said multiple servers and displayed upon a computer screen.

4. The computer driven systematic method for estate asset organizational according to claim 1 wherein a user may define their wishes with respect to final services and disposition of their remains, design their grave markers and inscriptions, write their own obituaries and select a picture to accompany their obituary.

5. The computer driven systematic method for estate asset organizational according to claim 1 wherein all passwords and data is encrypted.
